(19) United States
(12) Patent Application Publication
(10) Pub. No.: US 2019/0301225 A1
(43) Pub. Date: Oct. 3, 2019

(54) METHOD FOR THE MANAGEMENT AND CONTROL OF ACCESSES

(71) Applicant: VISION S.R.L., Merano BZ (IT)

(72) Inventor: Patrick LOMSDALEN OSTI, Merano BZ (IT)

(21) Appl. No.: 16/335,623

(22) PCT Filed: Sep. 15, 2017
(86) PCT No.: PCT/IB2017/055589

§ 371 Date: Mar. 21, 2019

(30) Foreign Application Priority Data
Sep. 23, 2016 (IT) 102016000095844

(51) Int. Cl. E05F 15/40; H04W 12/06; H04W 4/33

(52) U.S. Cl. CPC E05F 15/40; H04W 12/0609; H04W 4/33; E05Y 2900/10; E05Y 2400/10; E05Y 2400/664; E05Y 2800/426

(57) ABSTRACT

The present invention relates to a method, implemented by means of a computer, for the management of accesses to premises of a building having doors and the control of opening electronic devices of said doors by a user.

The present invention relates to a method, implemented by means of a computer, for the management of accesses to premises of a building having doors and the control of electronic devices for opening said doors by a user.

### BACKGROUND

Privacy protection is a subject of great topical interest and the use of information about users for different purposes is a particularly delicate subject. The new regulations about the matter, at European and national level, are being developed.

In particular, the present description relates to the collection of personal data during the steps for registering to services of various nature, and in particular to a service for managing and controlling accesses in locations such as hotel rooms or the like.

All solutions known up to now necessarily require a recording to the service which provides for the despatch of personal data, email address, etc. to the provider of the service itself who stores them for not wholly defined reasons and possible subsequent uses.

Moreover such recording modes always involve additional passages by the user, such as for example a step of acknowledging the email address (for safety reasons). Then, the registration procedure sometimes results to be heavier and longer than necessary even for the user itself.

For example, there are systems for controlling accesses to be able to access hotel rooms by means of smartphone, which however require a complete registration and generally provide the following steps

1. The user downloads an application;

2. He/she registers by means of his/her email address or username;

3. He/she has to enter his/her electronic mailbox;

4. He/she has to check that an acknowledgement email has arrived;

5. He/she has click on the link to acknowledge his/her own email address;

6. He/she has to come back to the application;

7. He/she has to run a Check-In;

8. He/she has to wait for the reception of a digital key.

### TECHNICAL PROBLEM SOLVED BY THE INVENTION

The present invention places indeed in this field and it proposes, as solution to the above-mentioned problems, a process for the management of accesses to premises of a building having doors and the control of electronic devices for opening said doors by a user.

The object of the present invention then is to solve the problems of already known techniques, and this is obtained through a method as defined in claim 1.

The present invention also relates to a computer software implementing the invention method, as defined in claim No. 4.

Additional features of the present invention are defined in the corresponding depending claims.

The proposed solution consists in a computer process which allows the end user (hotel guest and/or staff) to access the room by using a smartphone (or other mobile device of personal type), by simply entering a booking code in an application existing in the device, by avoiding the typical registration procedure with email and/or phone number checking.

The main steps provided by the method according to the invention then are the following ones:

1. The user downloads and installs an application;

2. He/she enters an authorization code

3. He/she receives the digital key to access the room.

Then, the proposed solution makes it possible to run a wholly automatized hotel Check-In without requiring the intervention of physical people. For example, a booking web portal could send the acknowledgment to the hotel management system, which automatically assigns a room to the user and sends/forwards the authorization code to the same user.

Other advantages, together with the features and the use modes of the present invention, will result evident from the following detailed description of preferred embodiments thereof, shown by way of example and not with limitative purposes.

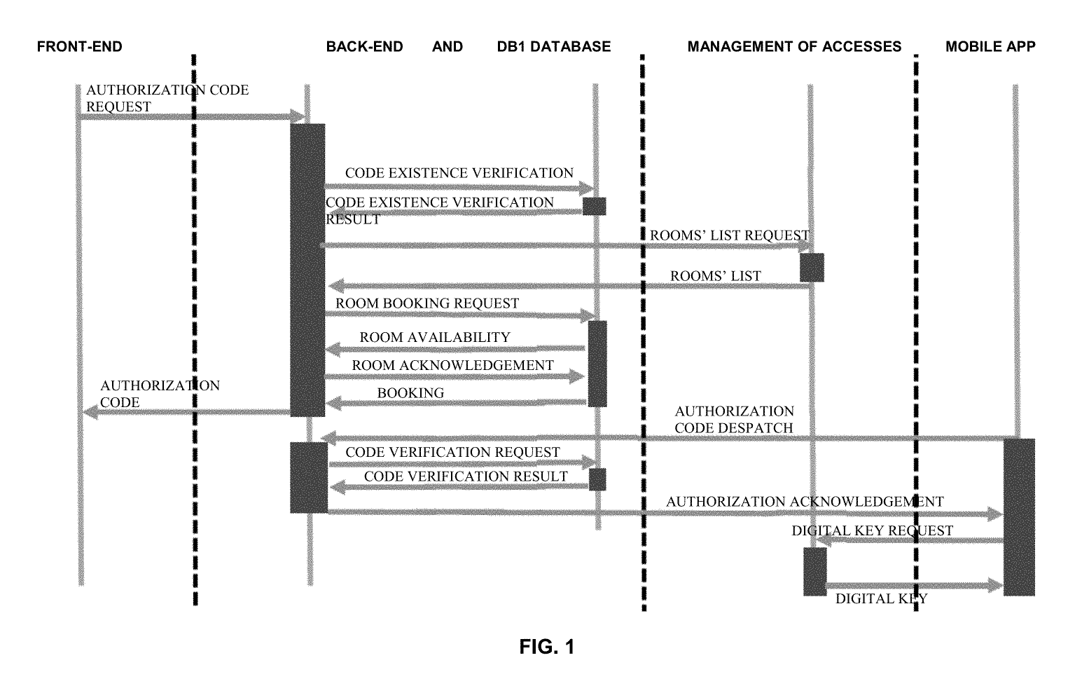

The present invention will be described hereinafter by referring to the enclosed FIG. 1 which represents an exemplifying diagram showing the main steps of a method according to a possible embodiment of the present invention.

Hereinafter in the present description, by pure way of example, the case of hotel premises, and then the management of the accesses to the rooms' doors by users who are guests of the hotel itself, will be referred to.

However, it is to be meant that the same principle could advantageously be exploited in other fields whenever there is the same need and/or the same advantages can be taken from the use of the present invention.

From an architectural point of view, the procedure revolves around a back-end process, preferably implemented like a webservice, for example implemented in Java on tomcat platform. This webservice is based upon a DB1 database (for example of MySQL type) including all data related to the project.

The access to the back-end is implemented by a web application acting as front-end.

This offers several advantages, such as the possibility of dividing the development of back-end and front-end without having to modify necessarily both of them. Moreover, the fact of having a webservice back-end also offers the possibility of being able to extend the front-end in a second moment, for example for adapting to applications dedicated to tablets or other.

Advantageously, in order to offer a very high safety level, it optionally can be provided that every communication is based upon HTTPS (http+SSL). In order to authenticate the users several safety concepts can further be integrated (for example: AWS documentation, Signing and Authenticating REST Requests).

In general terms, a method according to the present invention, then intended to be implemented by means of a computer, allows the management of accesses to premises of a building having electronic doors and the control of devices for opening said doors by a user.

Of course, it is to be meant that the process which will be described will not have to be performed entirely on the same machine. On the contrary, some steps will be performed by the back-end, others by the front-end, still others by the personal mobile device of the user, for example his/her smartphone.

Consequently, it is clear that the computer software implementing the method according to the invention could include several applications (of web, mobile, etc., type) each one intended to perform some steps of the method and suitable to be run on a corresponding machine.

Given the above, the method first of all provides a step for generating a univocal authorization code.

For example, the reception staff of a hotel, from a front-end application, could request to the back-end to produce an authorization code (which in case of hotels could identify a booking).

Advantageously, such code has a predetermined fixed length and it can be constituted by numerical and/or alphanumerical digits.

Obviously, the authorization code has to be univocal, then, the system has to be programmed so as to guarantee such univocity.

For example, the back-end application can check on DB1 database if the produced code already exists. Should it already exist, it could create a new one, until it finds a code which has not yet created or used. As soon as identified a “free” code it sends it as reply to the front-end application.

At this point, the method provides that an association of the authorization code to one of the doors be made.

According to a possible embodiment, additional data identifying a validity time period of the code itself can be further associated to the authorization code.

By way of example, the front-end could send a request to the back-end to receive the list of free rooms. The back-end, in turn, can connect to the software which manages the accesses to the hotel to obtain such list of rooms. In the end this list is sent to the front-end, through which the staff makes the association of the authorization code to one of the rooms (and then of the access doors).

The authorization code, at this point, can be provided to the user. Of course, this step can be performed in the most different ways. The code can simply be communicated or sent electronically directly to the user smartphone, etc.

At this point, the control of a device for opening a door by the user simply provides the steps described hereinafter.

The back-end application is programmed so as to be configured to receive, from a device of the user (for ex. his/her smartphone) an access request including exclusively the authorization code.

On the user device, as already explained, an application will be installed allowing to enter (or to recover) the authorization code and the despatch of the code towards the back-end.

The back-end application, once received the authorization code from the user device, could verify the association of the received authorization code with one of said doors. Such verification can be performed for example by accessing the DB1 database.

Whenever also data related to the validity period are associated to the authorization code, the verification could further provide a comparison of date and/or time of the request with respect to the validity time period of the authorization code.

Then, if the verification result is positive, the back-end returns to the application existing on the user mobile device an identifier of the door associated to the received authorization code, in case together with additional details of the booking itself (check-in date, check-out date, hours, hotel information and its services, etc.).

At this point, the application existing on the user mobile device could request to issue a digital key to be used to unlock the door's electronic lock. Such request is performed towards the management of the hotel accesses which indeed returns the digital key of the door associated to the authorization code.

At this point, the user mobile device (for ex. the smartphone) could communicate, by activating its own wireless data communication means, with the device for opening the door and unlock it by using the received digital key.

It is not considered to be necessary to describe in details the mechanisms for the mechanical and electronical operation of the electronic keys which can be actuated by smartphone, as they are already widely used and then to be considered within the comprehension of the a person skilled in the art. Analogously, it is not necessary to specify which type of wireless communications means is more advantageous to be used (Bluetooth, wifi, RFID, etc.) as this is irrelevant for the present invention, and however within the comprehension of a person skilled in the art.

The present invention has been described so far with reference to preferred embodiments thereof. It is to be meant that each one of the technical solutions implemented in the preferred embodiments, herein described by way of example, advantageously can be combined, differently from what described, with the other ones, to create additional embodiments belonging to the same inventive core and however within the protective scope of the here below reported claims.

1. A computer implemented method, for the management of accesses to premises of a building having doors and the control of opening electronic devices of said doors by a user, comprising:
generating a univocal authorization code;
associating said authorization code to one of said doors;
providing said authorization code to said user;
the control of an opening device by the user providing for:
receiving an access request containing only an authorization code by a device of said user;
verifying the association of the received authorization code with one of said doors; and
if the verification is positive:
providing to the device of said user an identifier of the door associated to the received authorization code;
providing to the device of said user a digital key of the door associated to the received authorization code; and
activating wireless data communication means of the device of said user for transmitting said digital key to the opening device of the door so as to actuate the opening thereof.

2. The method according to claim 1, further comprising associating to said authorization code additional data identifying a validity time period of the code itself.

3. The method according to claim 2, wherein said verifying the association of said code with one of said doors further comprises verifying date and/or time of the request with respect to said validity time period.

4. (canceled)

5. A non-transitory computer-readable medium, for the management of accesses to premises of a building having doors and the control of opening electronic devices of said doors by a user, storing computer-executable code for:
generating a univocal authorization code;
associating said authorization code to one of said doors;
providing said authorization code to said user;
the control of an opening device by the user providing for:
receiving an access request containing only an authorization code by a device of said user;
verifying the association of the received authorization code with one of said doors; and
if the verification is positive:
providing to the device of said user an identifier of the door associated to the received authorization code;
providing to the device of said user a digital key of the door associated to the received authorization code; and
activating wireless data communication means of the device of said user for transmitting said digital key to the opening device of the door so as to actuate the opening thereof.

6. The non-transitory computer-readable medium of claim 5, further comprising computer-executable code for associating to said authorization code additional data identifying a validity time period of the code itself.

7. The non-transitory computer-readable medium of claim 6, wherein said computer-executable code for verifying the association of said code with one of said doors further comprises computer-executable code for verifying date and/or time of the request with respect to said validity time period
